(19) United States
(12) Patent Application Publication
(10) Pub. No.: US 2007/0026708 A1
(43) Pub. Date: Feb. 1, 2007

(54) Connector and portable cable

(75) Inventor: Yuusuke Shiroyama, Kanagawa (JP)

Correspondence Address: MCCORMICK, PAULDING & HUBER LLP, CITY PLACE II, 185 ASYLUM STREET, HARTFORD, CT, 06103, US

(73) Assignee: KYOCERA ELCO CORPORATION, Kanagawa (JP)

(21) Appl. No.: 11/494,189

(22) Filed: Jul. 27, 2006

(30) Foreign Application Priority Data
Jul. 28, 2005 (JP) 2005-218982

(51) Int. Cl. H01R 13/62

(52) U.S. Cl. 439/157

(57) ABSTRACT

A connector includes a first connector provided with a first insulating member and a first contact, and a second connector provided with a second insulating member and a second contact which is electrically connected with the first contact by fitting the first and second insulating members together. A fitting projection is provided in one of the first and second insulating members so as to project toward the other of the first and second insulating members. A fitting recess, into which the fitting projection is fitted when the first and second insulating members are fitted, is provided in the other of the first and second insulating members. The fitting projection includes an engaging recess which extends entirely across the fitting projection in one direction. The fitting recess includes an engaging projection which is engaged with the engaging recess when the first and second insulating members are fitted together.

### CROSS REFERENCE TO RELATED APPLICATION

The present invention is related to and claims priority of the following pending application, namely, Japanese Patent Application No. 2005-218982 filed on Jul. 28, 2005.

### BACKGROUND OF THE INVENTION

1. Field of the Invention

The present invention relates to a connector having a receptacle connector and a plug connector which are mated with each other to establish electrical connection, and also relates to a portable terminal provided with such a connector.

2. Description of the Related Art

In a connector which has a receptacle connector and a plug connector mounted on respective substrates, and in which the receptacle and plug connectors are electrically connected to each other by inserting the plug connector into an insertion groove provided in the receptacle connector, there has been increasing demand for miniaturization. Specifically, since a portable terminal or other devices on which the connector is mounted is miniaturized, there has been increasing demand for a reduction in the profile height, and a reduction in the area that the connector occupies on the mounting substrate.

However, since the profile height and size of such a connector are reduced, the strength thereof is likely to decrease. Thus, even after the plug connector is fitted into the receptacle connector or after these connectors are mounted on respective substrates, cracks or fractures may occur if a load or external force caused by dropping, an impact, or the like is applied. This may cause conduction failure or short-circuit depending on the extent of the external force.

In view of the above noted problems, a connector has been disclosed in Japanese Patent Application Laid-Open No. 2002-8753. In this connector, the bottom of a socket body (a receptacle body) faces a header body (a plug body). In addition, a fitting piece is provided on the facing surface of the socket body (an insertion groove being formed around the periphery of the fitting piece), and a fitting groove is provided on the facing surface of the header body. Furthermore, the connector is provided with at least one set of a fitting recess provided on the facing surface of the fitting piece and a fitting projection provided on the facing surface of the fitting groove. The fitting recess and the fitting projection are fitted together along the direction of the header insertion and are formed such that the sizes thereof have almost no influence on the rectangular shapes of the fitting groove and the fitting piece. In this connector, the fitting recess and the fitting projection are fitted together when a header (a plug connector) is inserted into a socket (a receptacle connector). In this case, if an impact load generated in a direction approximately perpendicular to the insertion direction of the header is applied around the fitting recess of the socket body, the strength around the fitting recess remains relatively stable. Accordingly, the impact load applied to the periphery of the insertion groove of the socket body can be reduced, and a weld line can be easily formed in the periphery of the insertion groove. Therefore, fracture of the socket can be prevented, and the positioning accuracy between the socket body and the header body can be improved through the fitting recess and the fitting projection. Furthermore, connection failure between the contacts of the socket and the receiving contacts of the header can be prevented.

It should be appreciated, however, that if the profile height of the abovementioned connector is reduced to the extent that the distance between the substrates on which the receptacle connector and the plug connector are mounted respectively is less than 1 mm, the fitting recess and the fitting projection must have extremely fine shapes. Furthermore, since it is difficult to machine a mold for use in injection molding, it is difficult to accurately form the rectangular shapes of the fitting recess and the fitting projection, and thus the fitting projection may not be able to be fitted correctly into the fitting recess.

Furthermore, since the fitting recess and the fitting projection are fitted together in the fitting groove, they are subjected to twist, rotation, or other movements due to the clearance necessary for fitting the socket into the header. In addition, since the abutment area of the fitting recess against the fitting projection is small upon impact caused by dropping, or the like, the applied load or external force cannot be sufficiently dispersed. Therefore, the occurrence of cracks or fractures cannot be satisfactorily prevented.

### SUMMARY OF THE INVENTION

The present invention provides a connector including a first connector provided with a first insulating member and at least one first contact held by the first insulating member; and a second connector provided with a second insulating member and at least one second contact which is electrically connected with the first contact by fitting the first and second insulating members together. A fitting projection is provided in one of the first insulating member and the second insulating member so as to project toward the other of the first insulating member and the second insulating member. A fitting recess, into which the fitting projection is fitted when the first and second insulating members are fitted together, is provided in the other of the first insulating member and the second insulating member. The fitting projection includes an engaging recess which is provided so as to extend entirely across the fitting projection in one direction. The fitting recess includes an engaging projection which is engaged with the engaging recess when the first and second insulating members are fitted together.

It is desirable for the first insulating member to include an island portion provided in a center of the first insulating member; and an insertion groove provided between the island portion having an approximately rectangular shape and a wall portion arranged around the island portion. The second insulating member is provided with a fitting wall which is arranged around an insertion recess having an approximately rectangular shape and which is fitted into the insertion groove of the first insulating member when the first and second connectors are fitted together. The engaging projection is provided on a bottom surface of the fitting recess provided in the island portion of the first insulating member and protrudes toward the second insulating member. The engaging recess is provided in the fitting projection provided in the insertion recess of the second insulating member.

It is desirable for the fitting projection to include an island portion which has an approximately rectangular shape and is defined by insertion groove provided between the fitting projection and a wall portion arranged around the first insulating member. The fitting recess has an approximately rectangular shape and is provided in the second insulating member so as to be surrounded by a fitting wall which is fitted into the insertion groove when the first and second connectors are fitted together.

It is desirable for the engaging recess to be formed so as to extend entirely across the fitting projection and have an approximately rectangular shape in the width direction thereof.

It is desirable for at least two of the engaging recesses to be arranged at positions along a lengthwise direction of the fitting projection having an approximately rectangular shape so as to be symmetric about a center of the fitting portion.

It is desirable for the engaging recess and the engaging projection each to have an approximately rectangular shape.

It is desirable for the engaging projection to have a polygonal shape, and for the engaging recess to have a shape which restricts movement of the engaging projection in a direction perpendicular to a fitting direction of the first connector and the second connector when the engaging recess is engaged with the engaging projection.

It is desirable for the engaging projection to have an approximately circular shape, and for the engaging recess to have a shape which restricts movement of the engaging projection in a direction perpendicular to a fitting direction of the first connector and the second connector when the engaging recess is engaged with the engaging projection.

It is desirable for at least one of side faces of the engaging recess to be inclined with respect to the fitting direction of the first connector and the second connector; and for the engaging projection engaging with the engaging recess to have an inclined side face corresponding to the inclined side face of the engaging recess.

It is desirable for at least one pair of side faces of the engaging recess to be formed so that the side faces are mutually inclined so as to be closer to each other at an opening end of the engaging recess at an outer surface of the fitting projection which lies on a plane orthogonal to a fitting direction of the first connector and the second connector; and for the engaging projection, which engages with the engaging recess, to have dimensions which allow the engaging projection to be inserted into the engaging recess and have a similar shape to that of the engaging recess, the engaging projection including at least one pair of opposing side faces mutually inclined toward each other so that a width of an insertion end surface of the engaging projection is smaller than a width of the opening end of the engaging recess.

In an embodiment, a portable terminal is provided, including the above-described connector.

According to the present invention, since the engaging projection or the engaging recess can be formed without affecting the shape of the insertion groove designed taking into account the clearance for fitting, the fitting accuracy of the fitting wall into the insertion groove is not reduced. Furthermore, since the shapes of the engaging projection and the engaging recess can be designed independently of the design of the insertion groove, the engaging projection and the engaging recess can be easily designed in a shape which provides high precision engagement with each other. Moreover, since the engaging projection is formed on the bottom surface of the fitting recess, the projection can be formed so as to have a larger height in the fitting direction. In addition, since the engaging recess is formed on the surface of the fitting projection, the engaging recess can be formed so as to have a larger depth in the fitting direction. Therefore, the contact area between the engaging recess and the engaging projection can be increased. Hence, the reduction in the profile height can be achieved in the above-described manner. In addition, if an impact caused by dropping or the like is applied to the connector, the load or external force is easily dispersed, and the fit between the receptacle connector and the plug connector can be maintained. Furthermore, the occurrence of cracks or fractures can be prevented, and the connector can be manufactured efficiently.

### BRIEF DESCRIPTION OF THE DRAWINGS

The present invention will be discussed below in detail with reference to the accompanying drawings, in which:

FIG. 1A is a perspective view of a receptacle connector according to a first embodiment of the present invention;

FIG. 1B is a plan view of the receptacle connector shown in FIG. 1A;

FIG. 1C is a cross-sectional view taken along the line IC-IC of FIG. 1B;

FIG. 2A is a perspective view of a plug connector according to the first embodiment of the present invention;

FIG. 2B is a plan view of the plug connector shown in FIG. 2A;

FIG. 2C is a cross-sectional view taken along the line IIC-IIC of FIG. 2B;

FIG. 3A is a side view illustrating the state when the plug connector and the receptacle connector are fitted together, according to the first embodiment of the present invention

FIG. 3B is a side view illustrating the state after the plug connector and the receptacle connector are fitted together;

FIGS. 4A and 4B are plan views of an engaging projection and an engaging recess according to modified examples of the first embodiment of the present invention;

FIGS. 5A and 5B are vertical cross-sectional views along a fitting direction illustrating the configuration of an engaging projection and an engaging recess according to other modified examples of the first embodiment of the present invention;

FIG. 6A is a perspective view of a receptacle connector according to a second embodiment of the present invention;

FIG. 6B is a plan view of the receptacle connector shown in FIG. 6A;

FIG. 6C is a cross-sectional view taken along the line VIC-VIC of FIG. 6B;

FIG. 7A is a perspective view illustrating the configuration of a plug connector according to the second embodiment of the present invention;

FIG. 7B is a plan view of the plug connector shown in FIG. 7A;

FIG. 7C is a cross-sectional view taken along the line VIIC-VIIC of FIG. 7B; and

FIG. 8A is a side view illustrating the state when the plug connector and the receptacle connector are fitted together, according to the second embodiment of the present invention; and

FIG. 8B is a side view illustrating the state after the plug connector and the receptacle connector are fitted together.

### DETAILED DESCRIPTION OF PREFERRED EMBODIMENTS

Hereinafter, embodiments of the present invention will be described in detail with reference to the drawings.

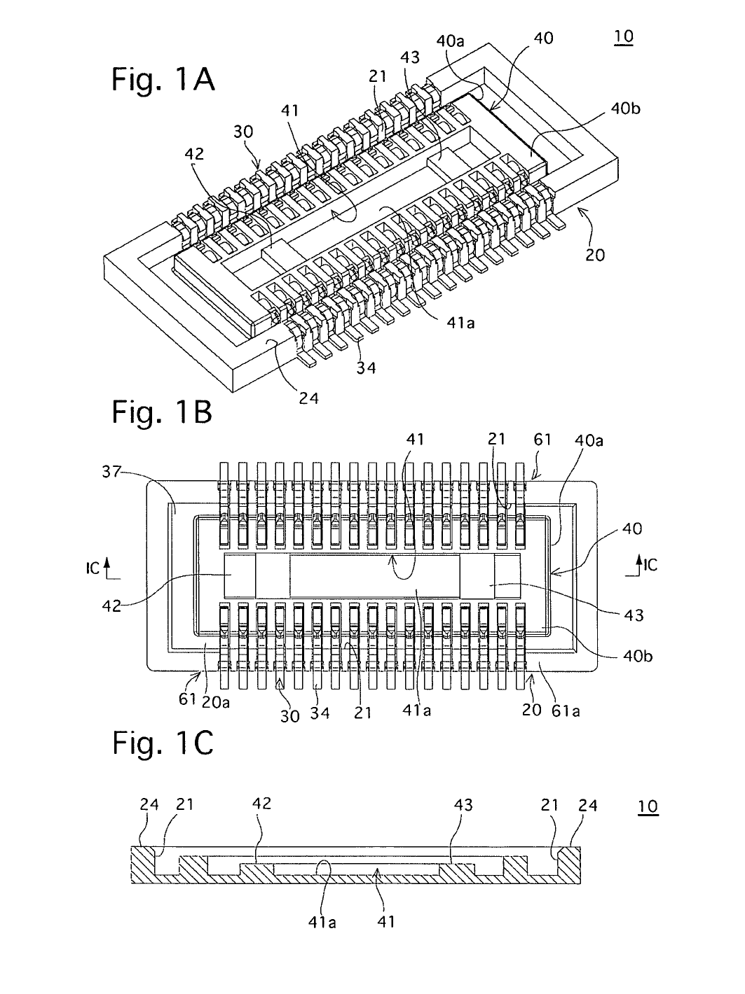

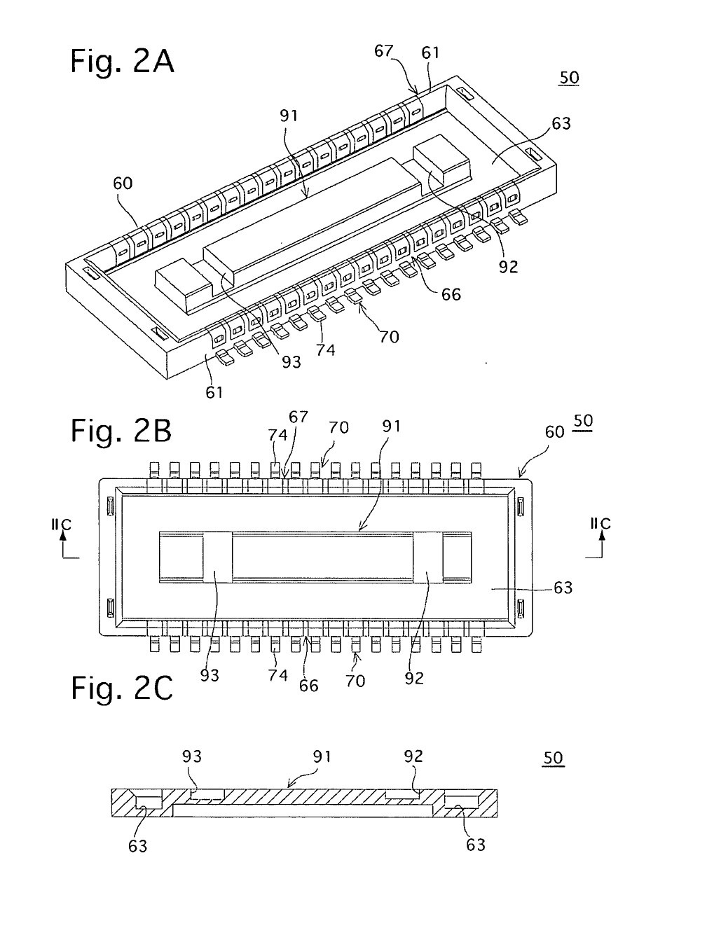

The connector according to the first embodiment is composed of a receptacle connector 10 (FIG. 1) and a plug connector 50 (FIG. 2) which are mated with each other (fitted together) to establish an electrical connection. For example, one of the receptacle connector 10 and the plug connector 50 is mounted on the substrate of an LCD (a liquid crystal display) unit (display device) or a CCD (a charge-coupled device) unit (imaging device). The other of the receptacle connector 10 and the plug connector 50 is placed on a substrate which is electrically connected to the unit to control the operation thereof. By mating the receptacle connector 10 with the plug connector 50, the unit is electrically connected with the substrate. The plug connector 50 and the receptacle connector 10, according to the illustrated embodiment, are applicable for providing connections within a portable terminal such as a cellular phone, or a PDA (Personal Digital Assistant) including a portable computer, and for providing connections between a portable terminal and an external device. Furthermore, the receptacle connector 10 and the plug connector 50 can be applied to a display device such as a CRT (Cathode Ray Tube) display unit, a plasma display unit, or an organic electroluminescent display unit, in addition to an LCD unit. In addition, the receptacle connector 10 and the plug connector 50 are applicable for use in an imaging device such as a CMOS (Complementary Metal Oxide Semiconductor) unit, in addition to an CCD unit.

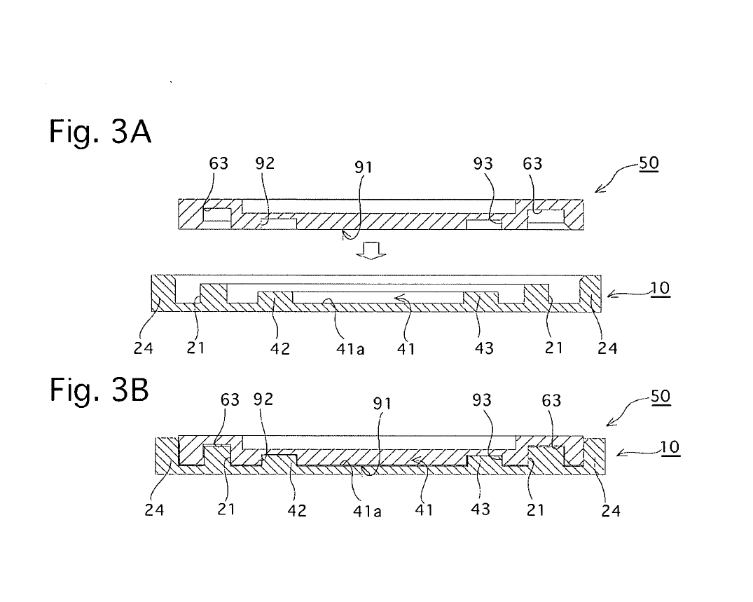

The receptacle connector (a first connector) 10 shown in FIG. 1 includes an approximately rectangular parallelepiped receptacle body (a first insulating member) 20 in which an insertion groove 21 is provided, and a plurality of receptacle contacts (first contacts) 30 provided on the both of the longitudinal sides of the insertion groove 21. The plug connector 50 can be mated with and unmated from the insertion groove 21. When the plug connector 50 is fitted into the receptacle connector 10, the plug connector 50 is placed on top of the receptacle connector 10 (see FIGS. 3A and 3B).

The receptacle body 20 has an approximately rectangular parallelepiped outer shape and includes an island portion 40 provided in the center of the receptacle body 20, the island portion 40 having an approximately rectangular shape, an approximately rectangular wall portion 24 formed around the periphery of an external surface 40a of the island portion 40; and the insertion groove 21 provided between the island portion 40 and the wall portion 24, wherein the plug connector 50 is mated with and unmated from the insertion groove 21. The receptacle body 20 is formed by injection molding a synthetic resin which is an insulating member. Examples of an insulating material for the insulating member include nylon 9T (a registered trademark), modified nylon, and a liquid crystal polymer.

A fitting recess 41 is provided at the center of the island portion 40, and a fitting projection 91 of the plug connector 50 is fitted into the fitting recess 41. Engaging projections 42 and 43, having an approximately rectangular parallelepiped shape, are provided on a bottom surface 41a of the fitting recess 41 so as not to project above an upper surface 40b of the island portion 40 and so as to extend across the fitting recess 41 in the lateral direction of the receptacle body 20. The engaging projections 42 and 43 are arranged at respective positions along the lengthwise direction of the fitting recess 41 so as to be symmetric about the center of the fitting recess 41. The height and the width of the engaging projections 42 and 43 may be arbitrarily chosen in consideration of the flowability of an employed material and required drop impact resistance.

As described above, by forming the engaging projections 42 and 43 inside the fitting recess 41 isolated from the insertion groove 21, these engaging projections 42 and 43 do not have influence on the shape of the insertion groove 21, which has been designed to take into consideration the clearance (the fitting clearance) for fitting the fitting wall 61 into the insertion groove 21. Hence, the fitting accuracy of a fitting wall 61 of the plug connector 50 into the insertion groove 21 is not diminished by the formation of the engaging projections 42 and 43. Furthermore, since the shapes of the engaging projections 42 and 43 can be designed independently of the design of the insertion groove 21, the engaging projections 42 and 43 can be easily designed to form a shape which provides high precision engagement with engaging recesses 92 and 93 of the plug connector 50. Moreover, since the engaging projections 42 and 43 are formed on the bottom surface 41a of the fitting recess 41 provided in the island portion 40, these engaging projections 42 and 43 can be formed such that the height thereof in the fitting direction is larger than that in the case where, for example, the engaging projections are formed on the upper surface 40b of the island portion 40. Therefore, the contact area with the engaging recesses 92 and 93 can be increased.

In the embodiment described above, if an impact caused by dropping, or the like, is applied, the load or external force is easily dispersed, so that the fit between the receptacle connector 10 and the plug connector 50 is maintained, and the occurrence of cracks or fractures can be prevented. In addition, since the engaging projections 42 and 43 can be formed relatively largely so long as the projections are formed inside the fitting recess 41, the share strength of the connection can be enhanced.

The receptacle contacts 30 are formed from strip-shaped metal members formed by stamping. In this case, a base material (for example, phosphor bronze) is subjected to primary plating (for example, nickel plating) followed by final plating (for example, gold plating), and the plated base material is then bent to form a predetermined shape. With regard to miniaturization and reduction in profile height of the connector, and also taking spring design and manufacturing efficiency into consideration, it is desirable that the thickness of the receptacle contacts 30 be 0.05 mm to 0.15 mm with the connector pitch being, for example, 0.3 mm to 0.5 mm. The receptacle contacts 30 are press-fitted into the receptacle body 20 so as to be fastened in the insertion groove 21, and thus the receptacle connector 10 is completed. This receptacle connector 10 is mounted on a mounting object (for example, a circuit substrate) by soldering and fixing receptacle-side terminals 34 of the receptacle contacts 30, extending outside the insertion groove 21, to a conductive pattern on the mounting object.

The plug connector (a second connector) 50 shown in FIG. 2 includes a plug body (a second insulating member) 60 and a plurality of plug contacts (second contacts) 70. The plug body 60 has an approximately rectangular parallelepiped shape and is an insert molded product which is an insulating member formed from a synthetic resin. The plug contacts 70 are formed from strip-shaped metal members and are arranged on the two lengthwise sides of the plug body 60 along the lengthwise direction thereof so that the pitch of the plug contacts 70 is the same as the corresponding pitch of the receptacle contacts 30 in the receptacle connector 10.

The plug body 60 has an approximately rectangular parallelepiped outer shape, and the fitting wall 61 is arranged therearound so as to surround an insertion recess 63 having an approximately rectangular shape. The fitting wall 61 is fitted into the insertion groove 21 of the receptacle connector 10 when the plug connector 50 is fitted into the receptacle connector 10. The plug body 60 is an insulating member made of, for example, nylon 9T (a registered trademark), modified nylon, or a liquid crystal polymer, and is integrally molded (insert molded) with the plug contacts 70.

The fitting projection 91 is provided in the center of the insertion recess 63 and is fitted into the fitting recess 41 of the receptacle connector 10 when the plug connector 50 is fitted into the receptacle connector 10. The engaging recesses 92 and 93, having a shape for fitting with the engaging projections 42 and 43, are provided in the fitting projection 91 at respective positions corresponding to the positions of the engaging projections 42 and 43. The engaging recesses 92 and 93 are formed on the fitting projection 91 toward the base of the insertion recess 63. The engaging recesses 92 and 93 are provided at positions along the lengthwise direction of the fitting projection 91, having an approximately rectangular shape so as to be symmetric about the center of the fitting projection 91, and are formed so as to extend across the fitting projection 91 in the width direction.

As described above, by forming the engaging recesses 92 and 93 inside the fitting projection 91 in isolation from the fitting wall 61, the engaging recesses 92 and 93 do not have influence on the shape of the fitting wall 61, which has been designed to take into account the clearance for fitting the fitting wall 61 into the insertion groove 21 of the receptacle connector 10. Hence, the fitting accuracy of the fitting wall 61 into the insertion groove 21 is not diminished by the formation of the engaging recesses 92 and 93. Furthermore, since the shapes of the engaging recesses 92 and 93 can be designed independently of the design of the fitting wall 61, the engaging recesses 92 and 93 can be easily designed in a shape which provides high precision engagement with the corresponding engaging projections 42 and 43 of the receptacle connector 10. Moreover, since the engaging recesses 92 and 93 are formed in the fitting projection 91 provided in the insertion recess 63, the engaging recesses 92 and 93 can be formed so that the depth thereof in the fitting direction is larger than that in the case where, for example, the engaging recesses (equivalent to the engaging recesses 92 and 93) are formed in the insertion recess 63. Therefore, the contact area between the engaging recesses 92 and 93 and the engaging projections 42 and 43, respectively, can be increased. In the embodiment described above, if an impact caused by dropping or the like is applied, the load or external force is easily dispersed. Therefore, the fit between the receptacle connector 10 and the plug connector 50 is maintained, and the occurrence of cracks or fractures can be prevented.

Furthermore, if the engaging projections 42 and 43 and the engaging recesses 92 and 93 are formed into simple shapes, since electrical discharge machining is not required, the edges thereof can be formed sharply without edge sagging. Accordingly, the engaging projections 42 and 43 can be accurately and reliably fitted into the engaging recesses 92 and 93 respectively, without deviation. Hence, even if a load or external force is applied upon dropping or impact, the fit between the engaging projections 42 and 43 and the engaging recesses 92 and 93 respectively, is not easily released, and accordingly the occurrence of cracks or fractures can be reliably prevented. Furthermore, in regard to the flowability of the synthetic resin during injection molding, since the engaging projections 42 and 43 and the engaging recesses 92 and 93 are formed into simple shapes, the filling of a injection mold therefor is facilitated. Accordingly, the filling density during molding is improved, and increased strength of the finished product is achieved. Furthermore, the shape of the injection mold can be more correctly transferred.

As described above, since the engaging recesses 92 and 93 are formed so as to completely extend across (through) the fitting projection 91 in the width direction, and the engaging projections 42 and 43 are formed into shapes corresponding to the shapes of the engaging recesses 92 and 93, the contact areas between the engaging recesses 92 and 93 and the engaging projections 42 and 43, respectively, can be increased in the width direction of the fitting projection 91. Hence, occurrence of cracks or fractures can be more reliably prevented when a load or external force at dropping or impact is exerted in the lengthwise direction of the plug connector 50 (the lengthwise direction of the fitting projection 91).

The plug contacts 70 are formed from a strip-shaped metal member formed by stamping. In this case, a base material (for example, phosphor bronze) is subjected to primary plating (for example, nickel plating) followed by final plating (for example, gold plating), and the plated base material is then bent to form a predetermined shape. With regard to miniaturization and reduction in profile height of the connector, and also taking spring design and manufacturing efficiency into consideration, it is desirable that the thickness of the plug contacts 70 be 0.05 mm to 0.15 mm with the connector pitch being, for example, 0.3 mm to 0.5 mm. Each of the plug contacts 70 is press-fitted into the plug body 60 so as to pass through a corresponding longitudinal wall 66 or 67 formed along the lengthwise direction of the plug body 60 so as to face to each other, and thus the plug connector 50 is completed. The plug connector 50 is mounted on a mounting object (for example, a circuit substrate) by soldering and fixing plug-side terminals 74 of the plug contacts, which extend outwards from the longitudinal walls 66 and 67 to a conductive pattern on the mounting object.

The receptacle connector 10 and the plug connector 50 having the above described configurations are mounted in advance at respective predetermined positions of respective mounting objects (for example, a circuit substrate or an FPC (flexible print circuit)) and are electrically connected with electric circuits through wiring conductors (not shown). Subsequently, the mounting object on which the plug connector 50 is mounted and the mounting object on which the receptacle connector 10 is mounted are arranged such that the receptacle connector 10 is placed face up and the plug connector 50 is placed face down, and correctly faces the receptacle connector 10. As shown in FIG. 3, the plug connector 50 and the receptacle connector 10 are fitted together (in the vertical direction shown in FIG. 3) by inserting the fitting wall 61 of the plug connector 50 into the insertion groove 21 of the receptacle connector 10 while the fitting projection 91 of the plug connector 50 is fitted into the fitting recess 41 of the receptacle connector 10 with the engaging projections 42 and 43 fitting into the engaging recesses 92 and 93, respectively.

It is desirable for the engagement clearance, i.e., the distance from the side faces of the engaging projections 42 and 43 to the corresponding facing side faces of the engaging recesses 92 and 93, to be between 0.005 mm to and 0.02 mm. By setting the engagement clearance smaller than the fitting clearance (i.e., the clearance for fitting the fitting wall 61 into the insertion groove 21), the engaging projections 42 and 43 are ensured to first abut against the engaging recesses 92 and 93 at the time of a drop impact, and the amount of positional displacement (the amount of movement of the plug connector 50 in the receptacle connector 10) can be restricted. It should be appreciated that the engagement clearance may be the same as the fitting clearance.

Furthermore, a fitting clearance may not be provided between the fitting wall 61 and the insertion groove 21. In such a case, by making the size of the engaging projections 42 and 43 slightly longer (desirably in a range from 0.005 mm to 0.2 mm) than the engaging recesses 92 and 93 in the lengthwise direction of the island portion 40, the engaging projections 42 and 43 can be made to elastically deform when fitted into the engaging recesses 92 and 93.

Hereinafter, modified examples will be described.

In the abovementioned embodiment, two engaging projections (42 and 43) and two engaging recesses (92 and 93) are provided. However, any number greater than two of the engaging projections and the engaging recesses may be provided so long as the same number of the engaging projections and the engaging recesses are provided at respective corresponding positions. Taking into consideration the balance between manufacturing cost and drop impact resistance, it is desirable to provide two engaging projections and two engaging recesses as in the above embodiment.

It is desirable for the engaging projections to be provided so as to be symmetric in the lengthwise direction of the fitting recess 41 about the center of the fitting recess 41 as in the engaging projections 42 and 43. Furthermore, it is desirable for the engaging recesses to be provided so as to be symmetric in the lengthwise direction of the fitting projection 91 about the center of the fitting projection 91 as in the engaging recesses 92 and 93. However, the engaging projections and the engaging recesses may be provided asymmetrically. In this case, the direction of the plug connector 50 with respect to the receptacle connector 10 can be limited.

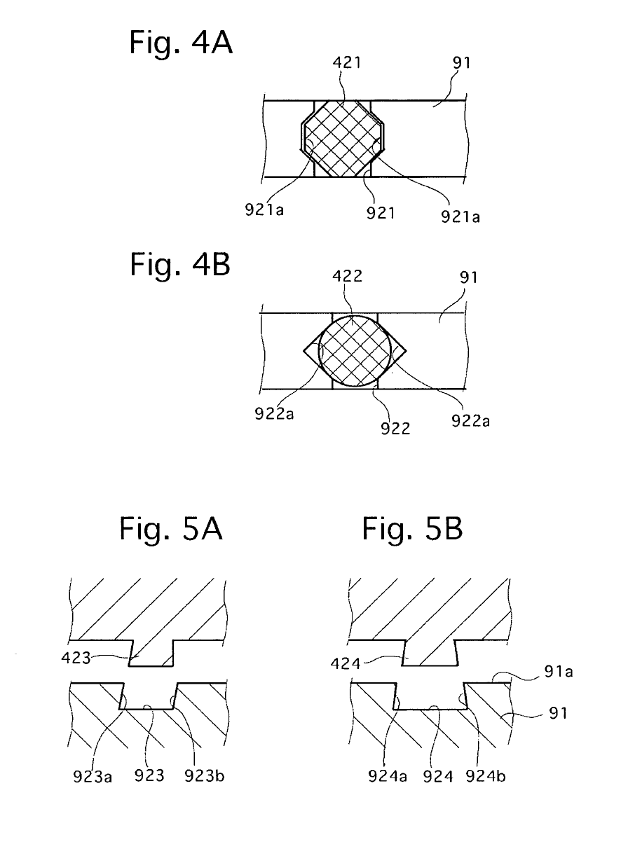

The shape of the engaging projection may be a polygon, a circle, or a shape similar thereto, in addition to the approximately rectangular shape as in the engaging projections 42 and 43. It is desirable for the engaging recess to have a shape capable of maintaining the fit with the engaging projection even when a load or external force caused by dropping or impact is applied. In addition to the approximately rectangular shape as in the engaging recesses 92 and 93, the shape of the engaging recess may be a shape capable of regulating the motion of the engaging projection in a plane perpendicular to the fitting direction of the receptacle connector 10 and the plug connector 50. For example, engaging projections 421 and 422 and engaging recesses 921 and 922 can be alternatively provided, as shown in FIGS. 4A and 4B. In this case, side recess portions 921a and 922a are formed at the centers of both sides of each pair of sides of the engaging recesses 921 and 922 so that portions of the respectively engaging projections 421 and 422 engage therewith. According to this arrangement, due to the engaging projections 421 and 422 respectively contacting the side recess portions 921a and 922a, not only is movement of the engaging projections 421 and 422 restricted in the lengthwise direction (horizontal direction in FIGS. 4A and 4B) of the fitting projection 91, movement of the engaging projections 421 and 422 is also restricted in the width direction (vertical direction in FIGS. 4A and 4B). Accordingly, the engaging projections 421 and 422 can be prevented from moving out of the engaging recesses 921 and 922, respectively, in the width direction of the fitting projection 91.

The engaging projection and the engaging recess may be formed so that the surface thereof extends parallel to the fitting direction of the receptacle connector 10 and the plug connector 50, like the engaging projections 42 and 43 (421 or 422) and the engaging recesses 92 and 93 (921 or 922) in the described above. However, as shown in FIG. 5A, an engaging recess 923 may be formed so that at least one pair of facing side faces 923a and 923b are parallel to each other and inclined with respect to the fitting direction. Furthermore, an engaging projection 423 engaging with the engaging recess 923 may be formed so that one side face corresponds to the side face 923a. In this case, if a load or external force caused by dropping or an impact is exerted on the engaging projection 423 in a direction of the side face 923a (the left side in FIG. 5A), the engaging projection 423 shifts towards the side face 923a (to the left with respect to FIG. 5A). However, in this case, since the side face 923a and the left side of the engaging projection 423, which have a mutually opposite inclining relationship, abut against each other, it is difficult for the engaging projection 423 to come out of the engaging recess 923 in an upward direction. Alternatively, as shown in FIG. 5B, at least one pair of facing side faces 924a and 924b of an engaging recess 924 may be formed so that the side faces 924a and 924b are mutually inclined toward each other so as to be closer to each other at the surface 91a of the fitting projection 91. Furthermore, an engaging projection 424 engaging with the engaging recess 924 may be formed so as to have dimensions which allow the engaging projection 424 to be inserted into the engaging recess 924 and have a similar shape to that of the engaging recess 924 (the width of the lower end of the engaging projection 424 is smaller than the width of the upper opening end of the engaging recess 924). In this case, if a load or external force caused by dropping or an impact is applied, the engagement between the engaging projection and the engaging recess is less likely to be released.

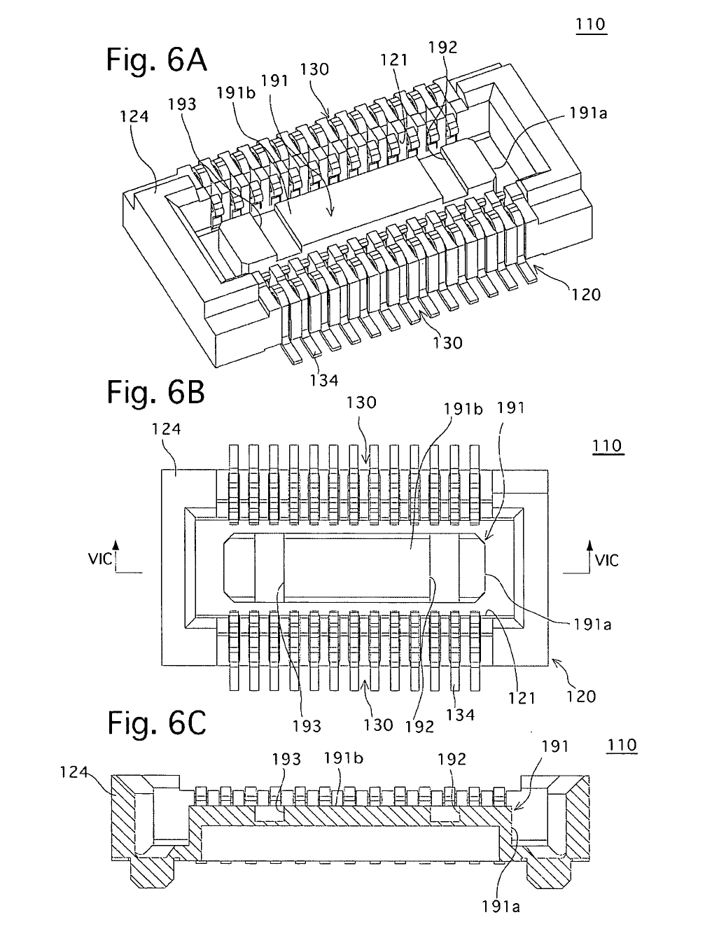

A description will be given of the second embodiment of the present invention with reference to FIGS. 6A through 8B. The second embodiment differs from the first embodiment in that a fitting projection and engaging recesses are provided in the receptacle body and that a fitting recess and engaging projections are provided in the plug body. The rest of the configuration is the same as that of the first embodiment, and the description same as that in the first embodiment will be omitted.

A receptacle connector (a first connector) 110 shown in FIGS. 6A, 6B and 6C is composed of an approximately rectangular parallelepiped receptacle body (a first insulating member) 120 in which an insertion groove 121 is provided, and a plurality of receptacle contacts (first contacts) 130 provided on the both sides of the insertion groove 121. A plug connector 150 (a second connector) is to be mated with or unmated from the insertion groove 121.

The receptacle body 120 has an approximately rectangular parallelepiped outer shape and includes an island portion (a fitting projection) 191 provided in the center of the receptacle body 120 having an approximately rectangular shape, an approximately rectangular wall portion 124 formed along an external surface 191a of the island portion 191, and the insertion groove 121 provided between the island portion 191 and the wall portion 124, the plug connector 150 being mated with or unmated from the insertion groove 121. The receptacle body 120 is an injection molded product which is an insulating member formed of a synthetic resin, likewise with the receptacle body 20.

In the island portion 191, engaging recesses 192 and 193 having a shape for fitting with engaging projections 142 and 143 of the plug connector 150 are formed on the island portion 191 from the upper surface 191b thereof toward the base surface of the insertion groove 121. The engaging recesses 192 and 193 are provided at positions along the lengthwise direction of the island portion 191 having an approximately rectangular shape so as to be symmetric about the center of the island portion 191, and are formed so as to extend across the island portion 191 in the width direction thereof.

The receptacle contacts 130 are placed so as to be fastened in the insertion groove 121, and receptacle-side terminals 134 extending outside the insertion groove 121 are soldered and fixed to a conductive pattern of a mounting object (for example, a circuit substrate).

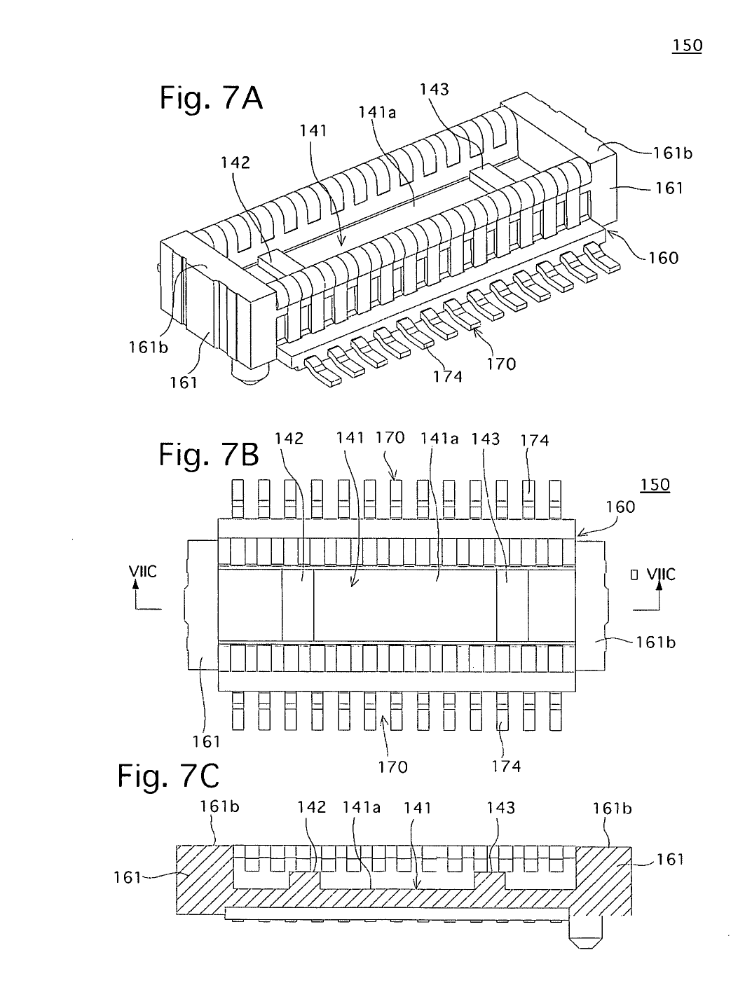

The plug connector (the second connector) 150 shown in FIGS. 7A, 7B and 7C is composed of a plug body (a second insulating member) 160 and a plurality of plug contacts (second contacts) 170. The plug body 160 has an approximately rectangular parallelepiped shape and is an insert molded product which is an insulating member formed of a synthetic resin. The plug contacts 170 are formed from a strip-shaped metal member and are arranged on the two sides of the plug body 160 along the lengthwise direction thereof so that the pitch of the plug contacts 170 is the same as the corresponding pitch of the receptacle contacts 130 in the receptacle connector 110.

The plug body 160 is an insulating member having an approximately rectangular parallelepiped shape and is integrally molded (insert molded) with the plug contacts 170, likewise with the plug body 60. A fitting wall 161 is arranged around the plug body 160 so as to surround a recess (a fitting recess) 141 having an approximately rectangular shape. The fitting wall 161 is fitted into the insertion groove 121 when the plug connector 150 is fitted into the receptacle connector 110. The engaging projections 142 and 143 having an approximately rectangular parallelepiped shape are provided on a bottom surface 141a of the recess 141 so as not to project above an upper surface 161b of the fitting wall 161 and so as to extend between the opposing portions of the fitting wall 161 in the width direction of the plug connector 150. The engaging projections 142 and 143 are formed at positions along the lengthwise direction of the recess 141 having an approximately rectangular shape so as to be symmetric about the center of the recess 141. The height and the width of the engaging projections 142 and 143 may be arbitrary chosen in consideration of the flowability of an employed material and required drop impact resistance.

Each of the plug contacts 170 is arranged so as to pass through a length-wise portion of the fitting wall 161 along the lengthwise direction of the plug body 160. Plug-side terminals 174 extending outside the fitting wall 161 are soldered and fixed to a conductive pattern of a mounting object (for example, a circuit substrate).

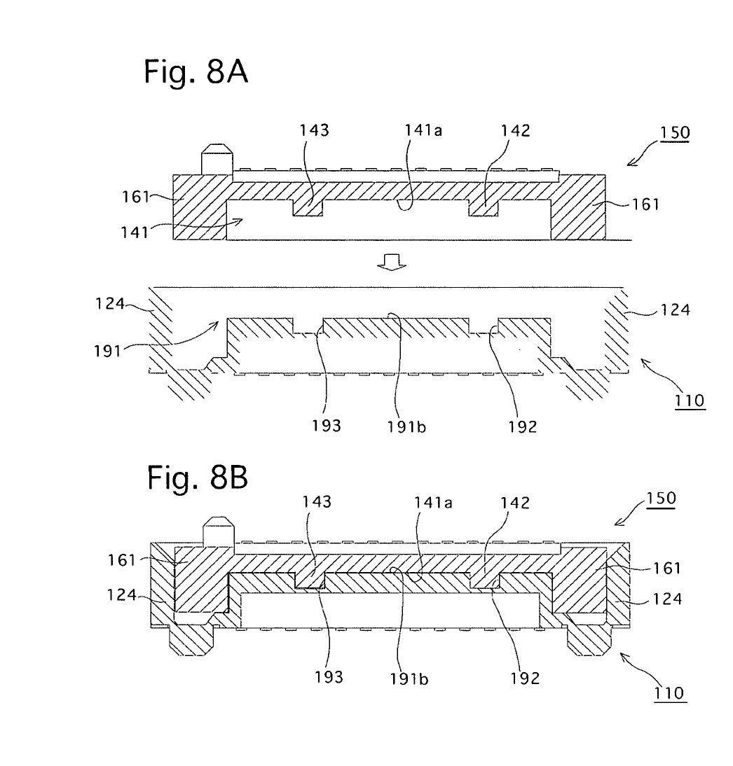

The receptacle connector 110 and the plug connector 150 having the above described configurations are mounted in advance at respective predetermined positions of respective mounting objects and are electrically connected with electric circuits through wiring conductors (not shown). The mounting object on which the receptacle connector 110 is mounted and the mounting object on which the plug connector 150 is mounted are arranged such that the receptacle connector 110 is placed face up and the plug connector 150 is placed face down and correctly faces the receptacle connector 110. The plug connector 150 is thereafter fitted into the receptacle connector 110 (in the vertical direction as shown in FIG. 8). The fit is achieved by inserting the fitting wall 161 of the plug connector 150 into the insertion groove 121 of the receptacle connector 110 while the island portion 191 of the receptacle connector 110 is fitted into the fitting recess 141 of the plug connector 150 (FIG. 8). At this time, the engaging projections 142 and 143 are fitted into the engaging recesses 192 and 193, respectively.

The other actions, advantages, and modified examples of the second embodiment are the same as those of the first embodiment.

The present invention has been described with reference to the above embodiments, but the invention is not limited to these embodiments. Improvements or modifications may be made within the purposes of the improvements or the spirit of the invention.

1. A connector comprising:
a first connector provided with a first insulating member and at least one first contact held by said first insulating member; and
a second connector provided with a second insulating member and at least one second contact which is electrically connected with said first contact by fitting said first and second insulating members together,
wherein a fitting projection is provided in one of said first insulating member and said second insulating member so as to project toward the other of said first insulating member and said second insulating member;
wherein a fitting recess, into which said fitting projection is fitted when the first and second insulating members are fitted together, is provided in said other of said first insulating member and said second insulating member;
wherein said fitting projection includes an engaging recess which is provided so as to extend entirely across said fitting projection in one direction; and
wherein the fitting recess includes an engaging projection which is engaged with said engaging recess when said first and second insulating members are fitted together.

2. The connector according to claim 1, wherein said first insulating member comprises:
an island portion provided in a center of said first insulating member; and
an insertion groove provided between said island portion having an approximately rectangular shape and a wall portion arranged around said island portion;
wherein said second insulating member is provided with a fitting wall which is arranged around an insertion recess having an approximately rectangular shape and which is fitted into said insertion groove of said first insulating member when the first and second connectors are fitted together;
wherein said engaging projection is provided on a bottom surface of said fitting recess provided in said island portion of said first insulating member and protrudes toward the second insulating member; and
wherein said engaging recess is provided in said fitting projection provided in said insertion recess of said second insulating member.

3. The connector according to claim 1, wherein said fitting projection comprises an island portion which has an approximately rectangular shape and is defined by insertion groove provided between said fitting projection and a wall portion arranged around said first insulating member; and
wherein said fitting recess has an approximately rectangular shape and is provided in said second insulating member so as to be surrounded by a fitting wall which is fitted into said insertion groove when said first and second connectors are fitted together.

4. The connector according to claim 1, wherein said engaging recess is formed so as to extend entirely across said fitting projection and have an approximately rectangular shape in the width direction thereof.

5. The connector according to claim 1, wherein at least two of said engaging recesses are arranged at positions along a lengthwise direction of said fitting projection having an approximately rectangular shape so as to be symmetric about a center of said fitting projection.

6. The connector according to claim 1, wherein said engaging recess and said engaging projection each have an approximately rectangular shape.

7. The connector according to claim 1, wherein said engaging projection has a polygonal shape; and
wherein said engaging recess has a shape which restricts movement of said engaging projection in a direction perpendicular to a fitting direction of said first connector and said second connector when said engaging recess is engaged with said engaging projection.

8. The connector according to claim 1, wherein said engaging projection has an approximately circular shape; and
wherein said engaging recess has a shape which restricts movement of said engaging projection in a direction perpendicular to a fitting direction of said first connector and said second connector when said engaging recess is engaged with said engaging projection.

9. The connector according to claim 1, wherein at least one of side faces of said engaging recess is inclined with respect to said fitting direction of said first connector and said second connector; and
wherein said engaging projection engaging with said engaging recess has an inclined side face corresponding to said inclined side face of said engaging recess.

10. The connector according to claim 1, wherein at least one pair of side faces of said engaging recess are formed so that said side faces are mutually inclined so as to be closer to each other at an opening end of said engaging recess at an outer surface of said fitting projection which lies on a plane orthogonal to a fitting direction of said first connector and said second connector; and
wherein said engaging projection, which engages with said engaging recess, has dimensions which allow said engaging projection to be inserted into said engaging recess, and has a similar shape to that of said engaging recess, said engaging projection including at least one pair of opposing side faces mutually inclined toward each other so that a width of an insertion end surface of said engaging projection is smaller than a width of said opening end of said engaging recess.

11. A portable terminal comprising a connector according to claim 1.
